(19) United States
(12) Patent Application Publication
(10) Pub. No.: US 2006/0160986 A1
(43) Pub. Date: Jul. 20, 2006

(54) Low viscosity unsaturated polyester resin with reduced VOC emission levels

(76) Inventor: Benjamin R. Hazen, Columbus, OH (US)

Correspondence Address: Martin Connaughton;ASHLAND INC., P.O. Box 2219, Columbus, OH, 43216, US

(21) Appl. No.: 11/038,749

(22) Filed: Jan. 18, 2005

(51) Int. Cl. C08G 63/02

(52) U.S. Cl. 528/272

(57) ABSTRACT

A method for the preparation of low viscosity unsaturated polyester resins is disclosed where in a first step a polyester resin is prepared from a dicarboxylic acid, its corresponding anhydride or mixtures thereof and polyhydric alcohol. In a second step the polyester resin is reacted with a saturated monohydric alcohol.

### BACKGROUND OF INVENTION

The present invention relates to polyester resins which contain low levels of styrene and a process for their preparation. In particular, the invention relates to a process for the preparation of unsaturated polyester resins having small alkyl groups at the ends of the polyester chain. The process utilizes a transesterification reaction between short chain alcohols and a previously formed unsaturated polyester resin wherein the polyester molecule is broken down into shorter chain molecules. Polar end groups such as carboxyl and glycol hydroxyl normally present on the unsaturated polyester molecule are replaced with the nonpolar alkyl groups of the short chain alcohol.

In general unsaturated polyesters are prepared from dicarboxylic functional monomers, or mixtures of di- or greater carboxyl functional monomers where at least one of the carboxyl functional monomers contains ethylenic unsaturation. These polyesters are obtained by the condensation of the carboxylic acid monomers with polyhydric alcohols. Commercially, the unsaturated polyester is dissolved in a monomer such as styrene to obtain a solution that can then be crosslinked.

U.S. Pat. No. 2,478,015 discloses a process for the preparation of unsaturated polyesters by reacting the monoester of a β-unsaturated monohydric alcohol and polycarboxylic acid with a polyhydric alcohol. Examples of the unsaturated alcohols include allyl alcohol, methallyl alcohol, crotyl alcohol, etc. β-unsaturated alcohols such as allyl alcohol are toxic and esters prepared using such alcohols have a tendency to gel. U.S. Pat. No. 3,547,898 discloses a process for the production of resins containing maleic half esters. In this process maleic acid or anhydride is reacted with a monoalkyl or alkaryl ethoxylate having from 4 to 15 carbon atoms in the alkyl or aralkyl group. An alcohol such as methanol may also be added to the reaction mixture. The reaction product is then dissolved in a monomer with a free radical initiator present. U.S. Pat. No. 3,979,443 discloses the preparation of monohydric alcohol esters of maleic acid. U.S. Pat. 4,038,340 discloses polyester resins based on polycarboxylic acids, polyhydric alcohols and monohydric alcohols. The polyester resins are prepared in a known manner. Losses of volatile alcohols which arise at the start of the polycondensation reaction are replenished by adding further alcohol. U.S. Pat. No. 5,118,783 discloses a process for preparing low molecular weight unsaturated polyesters by adding a monofunctional alcohol to the condensation reaction of dicarboxylic acids and polyhydric alcohol. Japanese Patent No. 2,863,896 discloses a process for the preparation of an ester derivative useful as a cross linking improver for polymers. The abstract of the ‘896 patent discloses reacting maleic anhydride with isopropanol, isomerizing the reaction product in the presence of an acid catalyst to give monoisopropyl fumarate and reacting that fumarate with a bisphenol A derivative at a temperature of 120° C. U.S. Pat. Nos. 6,107,446 and 6,222,005 disclose processes for the preparation of polyester resins comprising reacting a carboxylic acid or its corresponding anhydride with a saturated monohydric alcohol to form the half ester and then reacting the half ester with a polyol to form the polycondensate.

Styrene, a solvent used to prepare solutions of unsaturated polyesters is considered a hazardous pollutant. Much work has been done in an effort to prepare low volatile organic compound (VOC) unsaturated polyester resin systems. One area of focus has been the use of waxes as a means of reducing emissions. During curing waxes which are initially dissolved or dispersed in a resin, form a thin film on the surface of the fabricated article. The film acts as a physical barrier preventing styrene from evaporating from the surface of the curing part. This film reduces styrene emissions. Unfortunately the waxy film substantially diminishes interlaminar adhesion thus reducing the strength of molded articles made using a multilaminate construction. An alternative to the use of waxes is the use of low molecular weight unsaturated polyester resins. The lower molecular weight permits the use of less styrene because of increased solubility of the resin in the styrene. Typically the molecular weight of unsaturated polyester resins is manipulated by altering the ratios of components. The highest molecular weight is achieved when a 1:1 ratio of acid to polyol is used. Increasing the ratio of one component in relation to the other lowers the molecular weight. However, these synthesis techniques significantly change the performance characteristics of the resulting products. For example, using more polyol than acid can significantly reduce the reactivity and/or thermal resistance of a product. Using more acid than polyol will increase the reactivity but the acid value (AV) of the product also increases. High AV resins are not very soluble in styrene and tend to precipitate in styrene. Articles molded from these resins are susceptible to attack by water. Simply changing molecular weight without modifying the nature of the end groups diminishes the suitability of the resins for many applications.

### BRIEF SUMMARY OF THE INVENTION

The invention relates to a process for preparing unsaturated polyester resins. According to the process at least one dicarboxylic acid containing ethylenic unsaturation, its corresponding anhydride or mixtures thereof is first reacted with at least one polyhydric alcohol in a condensation reaction. After completion of the condensation reaction the condensation reaction product (unsaturated polyester resin) is reacted with a saturated monohydric alcohol. This process breaks down the unsaturated polyester resin chain into lower molecular weight chains. The alcohol end-capping replaces polar end groups such as carboxyl groups or glycol hydroxyls. Unsaturated polyester resins prepared according to the process of the invention are referred to as alcohol digested resins (ADR). The resins prepared according to the invention have low acid values and are more soluble in styrene than comparable resins prepared using a standard ester resin synthesis process where a carboxylic acid and polyol are reacted without further reaction with a saturated monohydric alcohol. Polyester resins prepared according to the invention have performance characteristics as good or better than polyester resins prepared by traditional methods.

### Brief Description Of The Several Views Of The Drawing [Not Applicable]

### DETAILED DESCRIPTION OF THE INVENTION

Unlike traditional unsaturated polyester resin syntheses processes comprising the reaction of an ethylenically unsaturated polycarboxylic acid or its corresponding anhydride and optionally other acids with a polyol in the presence of a condensation and or isomerization catalyst; the present invention further reacts the completed unsaturated polyester resin with a saturated monohydric alcohol, optionally in the presence of a transesterification catalyst. Other components common to the preparation of unsaturated polyester resins can be used in the present process.

Examples of dicarboxylic acids and corresponding anhydrides containing ethylenic unsaturation useful in the invention includes dicarboxylic acids and corresponding anhydrides such as, maleic acid, fumaric acid, itaconic acid and maleic anhydride. In addition other acids, anhydrides or esters of the acids can be added to modify the chemical composition. Examples of such acids and anhydrides include phthalic acid, isophthalic acid, terephthalic acid, tetrahydrophthalic anhydride, phthalic anhydride, nadic anhydride, methylnadic anhydride, hexahydrophthalic anhydride, dimethyl terephthalate, recycled terephthalate (PET) and the like. Maleic acid and maleic anhydride are preferred.

Saturated dicarboxylic acids and anhydrides can also be used in the preparation of the unsaturated polyester resin. Examples of such acids includes succinic acid, succinic anhydride, adipic acid, malonic acid, oxalic acid and the like. A wide variety of polyols can be used in the process of the invention. Included among these are common diols such as ethylene glycol, propylene glycol, 1,3-propanediol, 1,4-propanediol, 1,4-butanediol, 2,2-dimethyl-1,3-propanediol, 2-methyl-1,3-propanediol, glycol ethers such as diethylene glycol and dipropylene glycol, and polyoxyalkylene glycols like polyoxyethylene glycol and polyoxypropylene glycol. Triols and higher functional polyols such as glycerol, trimethylol propane and oxyalkylated adducts thereof can also be used. Preferably, the polyols are aliphatic or alicyclic and optionally contain C-O-C linkages.

Examples of saturated monohydric alcohols include alcohols having from 1 to 4 carbon atoms such as methanol, ethanol, 1-propanol, 2-propanol, n-butanol and the like. Primary alcohols having 1 to 3 carbon atoms such as methanol, ethanol and 1-propanol are preferred.

Other materials commonly used in the synthesis of unsaturated polyester resins, such as solvents, isomerization and/or condensation catalysts, transesterification catalysts, and the like can be used in the process of the invention. Examples of solvents are those commonly known in the art and include but are not limited to styrene, hexane, cyclohexane, benzene, toluene, xylene, and mixtures thereof. Commonly used inhibitors include hydroquinone, p-benzoquinone, di-t-butylhydroquinone, t-butyl catechol, phenothiazine, and the like. Catalysts used to promote the condensation reaction include p-toluene sulfonic acid, methane sulfonic acid, zinc salts (e.g. acetate), organotin compounds (dibutyl oxide) and other materials known to those skilled in the art. Isomerization catalysts include organic amines such as morpholine and piperidine. Catalysts used to promote the transesterification reaction include, zinc acetate and dibutyltin oxide. According to the invention an unsaturated polyester resin is formed and then reacted with a monohydric alcohol to form a polyester with alkyl groups at the ends of the polyester chain. The transesterification process between the monohydric alcohol and the unsaturated polyester resin also results in a polyester product having shorter chain lengths. The unsaturated polyester resin is prepared according to known methods using a common dicarboxylic acid or anhydride such as maleic anhydride and at least one glycol. The unsaturated polyester resin can contain dicyclopentadiene (DCPD) or other dicarboxylic acids. The condensation reaction between the dicarboxylic acid and the polyol is generally carried out at temperatures of from about 170° C. to about 240° C. In another embodiment the condensation reaction is carried out at a temperature of from about 170° C. to about 220° C. The reaction forming the unsaturated polyester resin is continued at temperature until an acid number value (AV) ASTM D1639 and styrenated viscosity ASTM D1824 within predetermined ranges are obtained. The unsaturated polyester resin is then cooled and reacted with a monohydric alcohol such as ethanol or methanol. For processing at atmospheric pressure, the alcohol addition can be carried out at temperatures as low as 60° C. with continuous reflux. A more efficient embodiment of the invention has the transesterification being carried out under pressurized conditions up to 300 psi. In an alternate embodiment the transesterification is carried out at pressurized conditions up to 100 psi. Under pressurized conditions the alcohol can be incorporated at temperatures of from about 60° C. to about 250° C. In an alternate embodiment the transesterification is carried out at temperatures of from about 60° C. to about 225° C. In another embodiment the transesterification is carried out at temperatures of from about 200° C. to about 210° C. The maximum pressure is limited by the capabilities of the reaction vessel. The maximum temperature is limited by the capabilties of the equipment and the decomposition temperature of the unsaturated polyester resin. In general, the higher the temperature and pressure, the faster the transesterification occurs. Whether the transesterification is carried out at atmospheric pressure or elevated pressure the alcohol incorporation efficiency is greater than 80%.

The predetermined AV depends on a number of factors including the ultimate use of the final product. For instance, the AV target for a finished laminating resin is 5-40. This target will allow enough acid in the system for the thermosetting reaction to take place efficiently. The residual acid catalyzes the peroxide and other promoters such as cobalt in the alcohol digested resin dissolved in a reactive monomer. If the AV is too high, phase separation within the styrenated resin can occur. The AV target for the “1^{ST} stage polyester before transesterification (alcohol digestion) is generally 5-20 units higher than the final target. This allows for incidental esterification to take place during the transesterification process. The incidental esterification serves to reduce the AV. The final viscosity target is chosen such that the finished resin will meet the viscosity/monomer ratio that the final fabrication process(open molding) and emissions regulations will accommodate. The viscosity target for the “1^{ST} stage polyester(before alcohol digestion)” is generally going to be higher than the final target. The first stage viscosity will be in a range such that when the predetermined alcohol charge is added and reacted, the final viscosity target will be achieved.

### EXAMPLE 1

In a general method for preparing an unsaturated polyester resin, propylene glycol, diethylene glycol, oxalic acid dihydrate, zinc acetate dihydrate and polyethylene terephthalate (PET) are charged to an empty reaction vessel with agitation. The reactor is sealed and heated to from 227° C. to 238° C. if capable of holding pressure. If the reactor is not capable of being pressurized the contents of the reactor are held at a temperature so as to maintain reflux until the PET is completely digested. The clearing of the reaction mixture signifies the digestion of the PET. On completion of the digestion of the PET the reaction mixture is cooled to 177° C. Maleic acid and maleic anhydride are then charged to the vessel. The reaction mixture is heated to from 204° C. to 210° C. and the reaction is monitored by acid value (AV) and viscosity until predetermined values are reached. Once the reaction is completed the newly formed unsaturated polyester resin can be mixed with a reactive diluent, inhibitors, etc. and stored or the process continued by reacting the unsaturated polyester resin with a saturated monohydric alcohol.

### EXAMPLE 2

### Atmospheric transesterification

An unsaturated polyester resin prepared according to the process of Example 1 comprising propylene glycol (337 moles), diethylene glycol (40 moles), phthalic anhydride (161 moles), recycled polyethylene terephthalate (equivalent to 161 moles terephthalic acid/ethylene glycol half ester) and maleic anhydride were reacted with methanol (50 moles) under atmospheric pressure at 60° C. The reaction was monitored by measuring the viscosity of the unsaturated polyester resin reaction product. Prior to reaction with methanol the unsaturated polyester resin had a viscosity of 1200 centipoise (cps) @ 25° C. when dissolved at 70 wt % solids in styrene. After completion of the transesterification reaction the unsaturated polyester resin had a viscosity of 500 cps @ 25° C. when dissolved at 70 wt % solids in styrene. Gas chromatography analysis showed that approximately 0.1 wt % of the methanol remained unreacted. Greater than 90% of the methanol had been incorporated into the unsaturated polyester resin.

### EXAMPLE 3

### Pressurized Transesterification

An unsaturated polyester resin prepared according to the process of Example 1 comprising propylene glycol (60 moles), diethylene glycol (7.1 moles ), recycled polyethylene terephthalate (equivalent of 28.6 moles terephthalic acid/ethylene glycol half ester), maleic anhydride (29.7 moles) was reacted with a mixture of ethanol (6.9 moles) and methanol (6.9 moles) under pressure at 210° C. The alcohol mixture was pumped at such a rate so as to keep the pressure in the vessel below the 50 psi rating of the rupture disk. The reaction was monitored by measuring the viscosity of the unsaturated polyester resin reaction product. Prior to reaction with the mixtures of alcohols the unsaturated polyester resin had a viscosity of 1300 centipoise (cps) @ 25° C. when dissolved at 70 wt % solids in styrene. The neat polyester acid value was 27 mg KOH/g resin. After completion of the transesterification reaction the unsaturated polyester resin had a viscosity of 500 cps @ 25° C. when dissolved at 70 wt % solids in styrene. About 15 weight percent of the alcohol charge was detected as unreacted using gas chromatography.

Having thus described the invention, I claim:

1. A process for the preparation of an unsaturated polyester resin, comprising the steps of;
A. forming the unsaturated polyester resin by reacting at least one dicarboxylic acid containing ethylenic unsaturation, its corresponding anhydride, or mixtures thereof with at least one polyhydric alcohol, and
B. reacting the unsaturated polyester resin with at least one saturated monohydric alcohol.

2. The process of claim 1, wherein the unsaturated dicarboxylic acid or the corresponding anhydride is maleic acid, fumaric acid, itaconic acid, maleic anhydride or mixtures thereof.

3. The process of claim 1, wherein forming the unsaturated polyester resin further comprises an acid selected from the group consisting of include phthalic acid, isophthalic acid, terephthalic acid, tetrahydrophthalic anhydride, phthalic anhydride, nadic anhydride, methyinadic anhydride, hexahydrophthalic anhydride, dimethyl terephthalate, recycled terephthalate (PET) and mixures thereof, in addition to the unsaturated dicarboxylic acid or the corresponding anhydride.

4. The process of claim 1, wherein the polyol is ethylene glycol, propylene glycol, 1,3-propanediol, 1,4-propanediol, 1,4-butanediol, 2,2-dimethyl-1,3-propanediol, 2-methyl-1,3-propanediol, diethylene glycol and dipropylene glycol, polyoxyethylene glycol and polyoxypropylene glycol, glycerol, trimethylol propane or mixtures thereof.

5. The process of claim 1, wherein the saturated monohydric alcohol has from 1 to 4 carbon atoms.

6. The process of claim 1, wherein the saturated monohydric alcohol has from 1 to 3 carbon atoms.

7. The process of claim 1, wherein the reaction of the unsaturated polyester resin with the saturated monohydric alcohol is carried out at atmospheric pressure.

8. The process of claim 1, wherein the reaction of the product of the unsaturated polyester resin with the saturated monohydric alcohol is carried out at a pressure of from atmospheric pressure to about 300 psi.

9. The process of claim 1, wherein the reaction of the unsaturated polyester resin with the saturated monohydric alcohol is carried out at a temperature of at least 60° C.

10. The process of claim 1, wherein the reaction of the unsaturated polyester resin with the saturated monohydric alcohol is carried out at a temperature from about 60° C. to about 250° C.

11. The process of claim 1, wherein the reaction of the unsaturated polyester resin with the saturated monohydric alcohol is carried out a pressure from atmospheric pressure to about 100 psi.

12. The process of claim 1, wherein the reaction of the unsaturated polyester resin with the saturated monohydric alcohol is carried out at a temperature greater than 60° C. and a pressure from atmospheric pressure to about 300 psi.

13. The process of claim 1, wherein the saturated monohydric alcohol is methanol, ethanol, 1-propanol, 2-propanol, 1-butanol or mixtures thereof.

14. The process of claim 1, wherein the formation of the unsaturated polyester resin is carried out in the presence of a catalyst.

15. The process of claim 1, wherein the reaction of the unsaturated polyester resin with the saturated monohydric alcohol is carried out in the presence of a catalyst.

16. The process of claim 1, wherein both the formation of the unsaturated polyester resin and the reaction of the unsaturated polyester resin with the alcohol are carried out in the presence of a catalyst.

17. An unsaturated polyester resin prepared according to the process of claim 1.
